(19) United States
(12) Patent Application Publication
(10) Pub. No.: US 2011/0107930 A1
(43) Pub. Date: May 12, 2011

(54) Device for Conveying a Flat Substrate having a Cleaning Device, and corresponding Cutting Device, Printing Press and Method

(75) Inventors: Nicolas Rousseau, Cinqueux (FR); Christophe Noiret, Saint Leu D'Esserent (FR); Francois Poiret, Vineul Saint Firmin (FR); Eric Pierda, Saint Leu D'Esserent (FR); Detlef Milkereit, Duesseldorf (DE)

(73) Assignees: Goss International Montataire S.A., Montataire (FR); VITS PRINT GMBH, Langenfeld (DE)

(21) Appl. No.: 12/990,604

(22) PCT Filed: Apr. 29, 2009
(86) PCT No.: PCT/FR2009/050790

§ 371 Date: Jan. 17, 2011

(30) Foreign Application Priority Data
Apr. 30, 2008 (FR) 08 52929

(51) Int. Cl. B41F 13/56; B26D 7/06; B65G 45/10; B65G 45/22

(52) U.S. Cl. 101/226; 83/78; 198/494; 198/495; 198/617

(57) ABSTRACT

The invention relates to a sheet (30) conveying device (D1, D2) comprising a transport roll (56, 58) for conveying a flat substrate (18, 30), said transport roll having a transport surface (82, 102) which comes into contact with the flat substrate and has a plurality of recesses (84, 104), and a vacuum device (64) for creating a depression in the plurality of recesses. The device also comprises a device (120) for cleaning the transport surface (82, 102). The invention is applicable to devices for ejecting sheets from printing presses.

The present invention concerns a device for conveying a flat substrate, such as a sheet or a web.

### BACKGROUND

Known in the prior art are devices for conveying printed products, such as sheets of paper. These conveying devices are for example used in offset printing machines to convey the printed sheets.

These conveying devices comprise hollow transport rolls having a transport surface in contact with the sheet to be transported.

To make the sheet adhere on the transport roll, the latter part has recesses connected to a device for creating a vacuum.

However, the printed sheet leads to depositions of ink on the transport surface, and results in poor production quality.

### SUMMARY OF THE INVENTION

An object of the present invention is to improve the quality of printed products that can be produced by the printing machine, using simple means.

The present invention provides a conveying device comprising a device for cleaning the transport surface.

According to specific embodiments, the conveying device may include one or several of the following features:
the cleaning device comprises an application device adapted to apply cleaning liquid on the transport surface;
the cleaning device comprises a tank containing cleaning liquid, and a duct adapted to convey said cleaning liquid to the application device;
the cleaning liquid is ink repellant liquid, in particular an emulsion of silicone and water;
the cleaning liquid is a washing liquid, preferably an ink solvent, and the cleaning device comprises a wiping device adapted to remove the washing liquid from the transport surface;
the wiping device is arranged downstream of the device applying the washing liquid, in the driving direction of the transport roll;
the conveying device defines a depression chamber extending over a first angular range around the axis of rotation of the transport roll, this first angular range extending over less than 360°;
the vacuum device is connected to the depression chamber and adapted to create a depression in the recesses found exclusively in the first angular range;
the conveying device defines an ambient chamber extending over a second angular range, the recesses found in the second angular range being subject to the ambient pressure;
the cleaning device cooperates with the transport surface within the second angular range;
the conveying device defines an overpressure chamber extending over a third angular range around the axis of rotation and comprises an overpressure device connected to the overpressure chamber and adapted to create an overpressure in the recesses found exclusively within the third angular range;
the transport roll is either an entrance roll, or an impression cylinder, or a transfer roll, or a braking roll.

The invention also provides a device for cutting a web into sheets of the type comprising:

a cutting cylinder provided with a blade;

an impression cylinder cooperating with the cutting cylinder, these cylinders being adapted to cut a flat substrate web into sheets;

a first device for conveying cut sheets by the cutting and impression cylinders, wherein the first conveying device is a device that includes a device for cleaning the transport surface, in particular a transfer device.

According to a preferred embodiment, the cutting device comprises a second device for conveying sheets, positioned downstream of the first device for conveying sheets, and the second conveying device is a device of the aforementioned type, in particular a braking device.

The invention also provides a rotary printing press, of the type comprising:

an unwinder for a web to be printed;

a unit for printing on the web to be printed;

a device for cutting the printed web into sheets, wherein the cutting device is a cutting device of the aforementioned type.

The invention also concerns a use of a conveying device of the aforementioned type, comprising the following steps:

creating a depression in at least part of the plurality of recesses,

providing a sheet to be conveyed,

conveying the sheet on the transport surface, and

cleaning the transport surface using the cleaning device.

### BRIEF DESCRIPTION OF THE FIGURES

The invention will be better understood upon reading the following description, provided solely as an example and done in reference to the appended drawings, in which:

FIG. 1 is a diagrammatic side view of a printing machine according to the present invention;

FIG. 2 is a view corresponding to the view of FIG. 1, of an alternative of a printing machine according to the invention;

FIG. 3 is a diagrammatic view of the cutting and stacking device according to a first embodiment; and

FIG. 4 is a diagrammatic view corresponding to the view of FIG. 3, of a second embodiment of the cutting and stacking device according to the invention.

### DETAILED DESCRIPTION

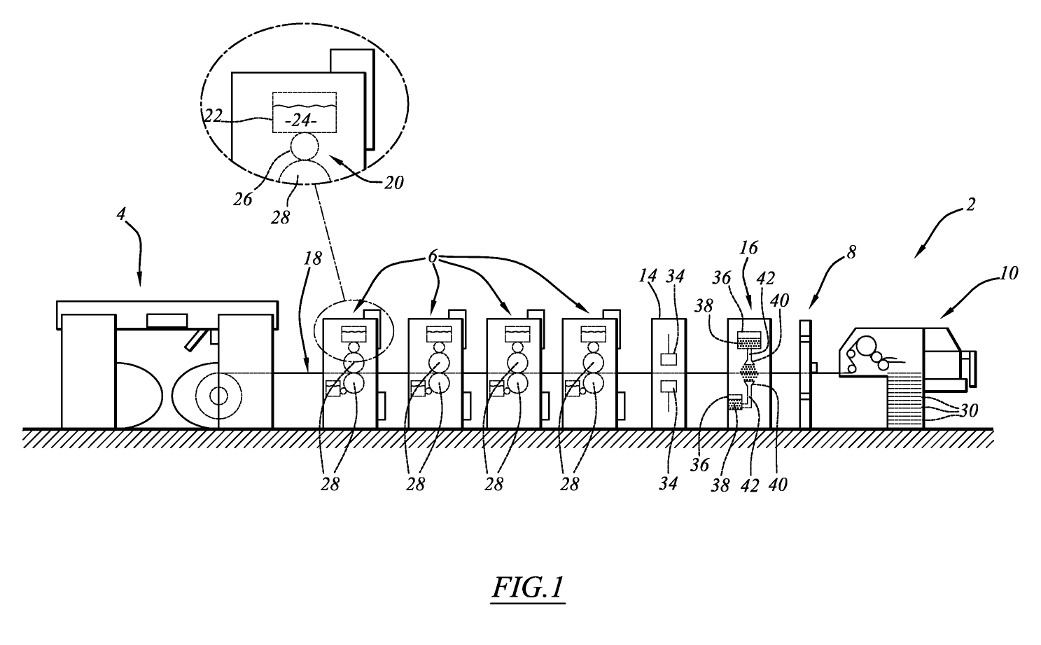

FIG. 1 shows a rotary printing machine according to the invention, designated by general reference 2.

The printing machine 2 comprises an unwinder 4, four printing units 6, a traction device 8, and a cutting and stacking device 10. The printing machine 2 also comprises a device for grasping a web 14 and a chalking device 16.

The printing machine 2 may comprise any number of printing units 6, in theory, from one to n.

The unwinder 4 is adapted to unwind a continuous web to be printed 18.

The web to be printed 18 is a web of coated paper. Coated paper is paper that comprises a coating layer, for example made of kaolin or chalk, improving the mechanical or optical properties of the paper. This paper makes it possible to obtain a high quality printed product. Alternatively, it is possible for the web to be printed to be a web of uncoated paper.

The printing machine 2 defines a printing path of the web 18 between the unwinder 4, through the printing units 6, the web capture device 14, the chalking device 16, and the traction device 8, up to the cutting and stacking device 10.

Each printing unit 6 includes an inking roller device 20 that is provided with an ink tank 22 comprising ink 24 provided for printing on a web of paper 18. The ink 24 used in the context of the invention will be explained below. Each inking roller device 20 also comprises an ink transfer roll 26 to transfer the ink 24 to the print rolls 28.

The printing units 6 comprise print rolls 28 that are adapted to print on a web of paper 18.

The cutting and stacking device 10 is adapted to cut the web to be printed 18 into individual sheets 30 and to produce a stack 31 of cut individual sheets.

The traction device 8 is situated downstream of the printing unit 6 farthest downstream and upstream of the cutting and stacking device 10. This traction device 8 is adapted to apply a determined mechanical traction on the web 18 coming out of the printing unit 6 farthest downstream.

As shown in FIG. 1, the printing machine 2 is adapted to transport the printed web 18 in free suspension and in ambient air over the entire path between the printing unit 6 farthest downstream and the traction device 8, possibly with the exception of the web capture device 14 and the chalking device 16. Moreover, the printing machine 2 is also adapted to transport the printed web 18 in ambient air over the entire path between the traction device 8 and the cutting and stacking device 10. Thus, the printing machine 2 of FIG. 1 does not include a dryer and has a small bulk.

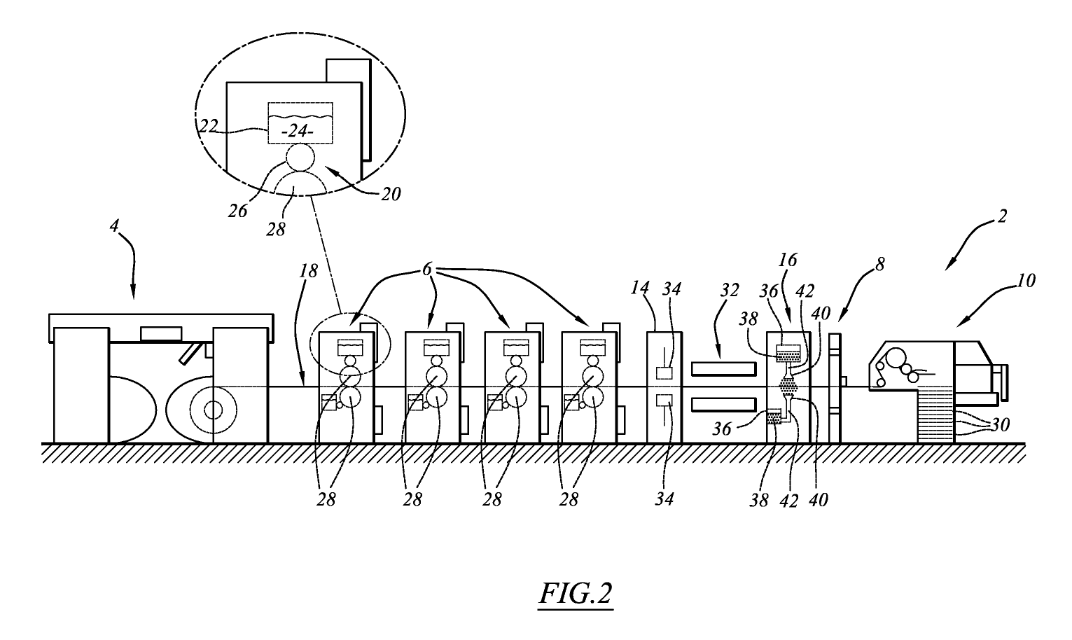

The printing machine 2 according to the alternative shown in FIG. 2 differs from the printing machine 2 shown in FIG. 1 by the fact that between the web capture device 14 and the traction device 8 is an infrared dryer 32 through which the printed web 18 is conveyed. The infrared dryer 32 can be replaced by another heat drying device of the web, such as a hot air dryer. The dryer 32 may have reduced dimensions in relation to the dryers of the prior art.

The web capture device 14 is adapted to detect a break in the paper web 18 and the catch the free end of the paper web 18 in that case. To that end, the web capture device 14 includes suitable capture elements 34. Alternatively, the web capture device 14 may be omitted.

The chalking device 16 is adapted to deposit anti-spotting powder on each of the faces of the printed web 18. It can deposit anti-spotting powder on one or both of the faces of the printed web 18. To that end, the chalking device 16 includes a tank 36 containing powder 38 and a chalking head 40 connected to the ink tank 36 by a duct 42, for each of the faces of the paper web 18.

The chalking device 16 is adapted to apply anti-spotting powder on the paper web 18 continuously, preferably continuously without interruption over a length corresponding to at least twice the printing length.

The anti-spotting powder 38 used to chalk the web is preferably a vegetable powder, for example corn-based, or a mineral powder.

The traction device 8, connected to the other units of the press, makes it possible to print a web of paper and receive the web in the cutting and stacking device 10, without drying the web of paper 12 and through evaporation of the ink solvents.

The image is printed by the ink 24 contained in the ink tank 22. Advantageously, the ink 24 is a siccative ink, or a waterless ink, or a bi-component ink. Drying of siccative inks is a combination of a first phenomenon called “penetration in the medium” and a second phenomenon called “oxido-polymerization of varnishes made up of oils and resins.”

Waterless inks are used with specific printing plates making it possible to define non-printing areas without using the traditional lithographic method based on the rejection of greasy ink by a previously moistened hydrophilic surface. The use of these inks can be considered in the same way as the traditional siccative inks previously seen and makes it possible to do away with a dryer, or to design it so that it is less bulky.

Heat-set inks, on the other hand, dry through evaporation of the mineral solvents mixed in with the resin. UV inks dry by polymerization of the resin under the effect of ultraviolet radiation.

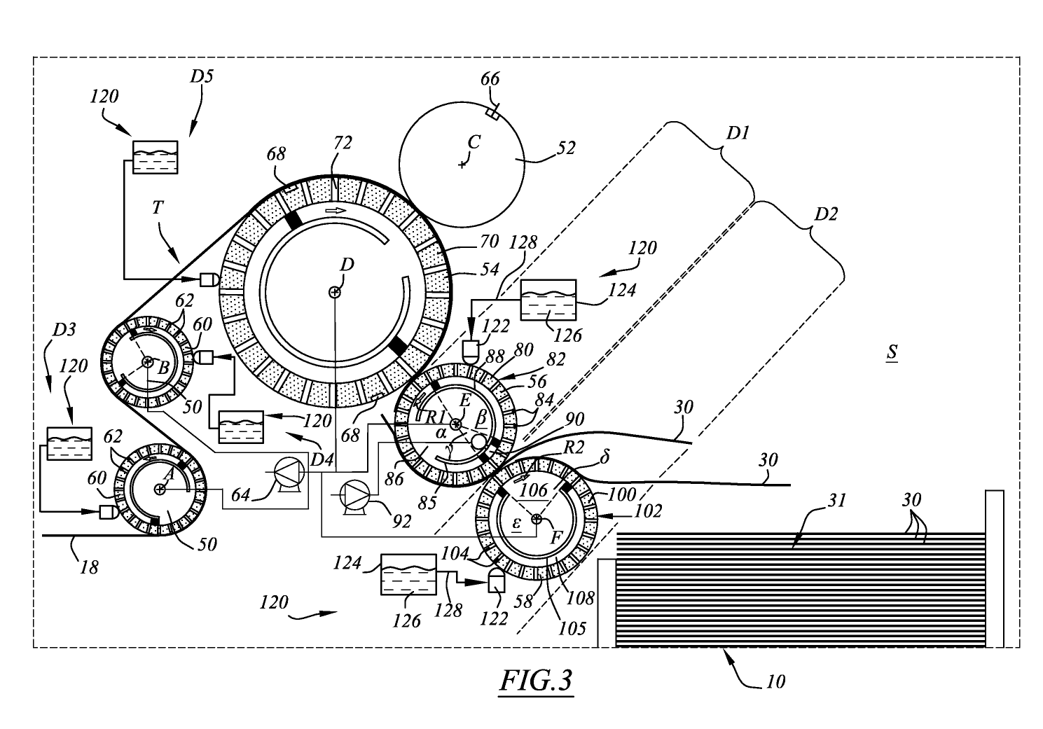

FIG. 3 diagrammatically illustrates the cutting and stacking device 10.

The cutting and stacking device 10 includes two devices for conveying sheets 30 towards the stack, i.e. a first conveying or transfer device D1 and a second conveying or braking device D2.

The cutting and stacking device includes two entering rolls 50, a cutting cylinder 52, an impression cylinder 54, a transfer roll 56 and a braking roll 58.

The cutting device 10 defines a path T of the paper web 18 and the sheets 30 extending from the entrance of said device 10 successively on the entering rolls 50, the impression cylinder 54, the transfer roll 56, the braking roll 58 up to a stack 31 of individual sheets 30.

The cutting and stacking device 10 includes a fixed structure S or frame.

The entrance rolls 50 are arranged on the path of the web of paper 18 upstream of the cutting cylinder 52 and the impression cylinder 54. The two entrance rolls 50 are able to rotate around an axis A and B in relation to the fixed structure S. Each of the entrance rolls 50 includes a jacket 60 having through-holes 62.

The cutting and stacking device 10 also includes a vacuum device 64 adapted to create a depression in the holes 62 over part of the circumference of the concerned entrance roll 50.

The cutting cylinder 52 is able to rotate in relation to the fixed structure S around an axis C. The cutting cylinder 52 includes a blade 66 adapted to cut the sheets 30 of the web of paper 18.

The impression cylinder 54 is positioned adjacent to the cutting cylinder 52 and is able to rotate in relation to the fixed structure S around an axis of rotation D. The impression cylinder 54 is for example provided with two impression blocks 68 regularly distributed on the circumference of the impression cylinder 54. These impression blocks 68 cooperate with the blade 66 to cut the web 18 into sheets 30.

Moreover, the impression cylinder 54 includes a jacket 70 provided with through holes 72. The jacket 70 is a hollow cylinder with a circular section. The inner portion of the jacket 70 is connected to the vacuum device 64. Thus, a vacuum or depression can be created on an angular portion of the circumference of the jacket 70 that corresponds to the path T of the web. This makes it possible to keep the web of paper 18 against the impression cylinder 54.

The first conveying device D1 is adapted to take a printed sheet 30, that has just been cut by the impression cylinder 54 and the cutting cylinder 52, and convey it along part of the path T.

The first conveying device D1 comprises the transfer roll 56.

The transfer roll 56 is provided with a jacket 80. The jacket 80 is able to rotate around an axis of rotation E in relation to the structure S. The jacket 80 is driven in a direction of rotation R1, which is the counterclockwise direction in the figures. The jacket 80 has a cylindrical shape with a hollow circular section, and defines a transport surface 82 adapted to be in contact with the sheet 30 to convey the sheet. The jacket 80 is provided with a plurality of through-holes 84, extending radially in relation to the axis of rotation E and emerging on the transport surface 82.

The first conveying device D1 includes a wall 85 that is fixed in relation to the structure S. This fixed wall 85 is positioned inside the jacket 80 and defines a depression chamber 86 extending over a first angular range α. This first angular range α extends over less than 360° around the axis of rotation E, and in this case over 180°. The depression chamber 86 is connected to the vacuum device 64. Thus, the first conveying device D1 is adapted to create a depression in the holes 84 situated exclusively in the part of the circumference of the jacket 80 corresponding to the first angular range α.

The fixed wall 85 defines an ambient chamber 88 extending over a second angular range β around the axis of rotation E. Thus, the holes 84 of the jacket 80 are subjected to ambient pressure on part of the circumference of the transport surface 82 corresponding to said second angular range. This second range extends over about 160° around the axis of rotation E.

The fixed wall 85 also defines an overpressure chamber extending over a third angular range γ around the axis of rotation E. The overpressure chamber 90 extends over about 20°. It is connected to an overpressure device 92 adapted to create an overpressure in the holes 84 located exclusively inside the third angular range.

The first angular range α coincides with the part of the path T associated with the transfer roll 56. The third angular range γ is located opposite the braking roll 58 and is adapted to push the sheet 30 towards said braking roll 58.

The conveying device D2 includes the braking roll 58.

The braking roll 58 is provided with a cylindrical jacket 100 with a hollow circular section that defines a transport surface 102. The jacket 100 is able to rotate around an axis of rotation F in relation to the structure S. The jacket 100 is driven in a direction of rotation R2, which is the direction opposite the direction R1. The jacket 100 is provided with a plurality of holes 104 passing through said jacket 100 and emerging on the transport surface 102.

The second conveying device D2 includes a wall 105 fixed in relation to the structure S. This fixed wall 105 is positioned inside the jacket 100 and defines a depression chamber 106 extending over a first angular range δ around the axis of rotation F. This first angular range δ extends over about 90° from the overpressure chamber 90 in the direction of rotation R2.

The conveying device D2 also defines an ambient chamber 108 extending over a second angular range ε of about 270° around the axis of rotation F. This ambient chamber 108 subjects the holes 104 found in the second range ε to the ambient pressure.

The second conveying device D2 is adapted to take a sheet 30 from the transfer roll 56 and brake it, then deposit it on the stack 31 of sheets.

Moreover, each of the first D1 and second D2 conveying devices includes a device 120 for cleaning the associated transport surface 82, 102. In the following, only one of the cleaning devices 120 will be described.

According to the embodiment of FIG. 3, the cleaning device 120 is an application device adapted to apply cleaning liquid on the transport surface 82 and 102. The cleaning device 120 comprises a tank 124 containing cleaning liquid 126, and a duct 128 adapted to convey said cleaning liquid 126 to the application device 122.

Preferably, the cleaning liquid 126 is ink repellant liquid, for example an emulsion of silicone and water. Preferably, the application device 122 is in contact with the transport surface 82, 102 at an angular location situated inside the second angular range β, ε which is connected to the ambient chamber 88, 108. Thus, the cleaning liquid is not suctioned in the holes 84, or ejected through the holes 84.

The application device 122 for example comprises a fabric that is moistened by the liquid 126.

The cutting device 10 of the first embodiment therefore does not have a device for wiping the cleaning liquid 126.

The cutting device 10 comprises third D3, fourth D4, and fifth D5 conveying devices.

The third D3 and fourth D4 conveying device are devices for conveying the web of paper 18 and comprise an entrance roll 50 each time.

Each of the third D3 and fourth D4 conveying devices comprises a cleaning device 120, identical to that described in reference to the first conveying device D1. This cleaning device 120 is adapted to clean the transport surface of the rolls 50.

The fifth conveying device D5 includes the impression cylinder 54 and a cleaning device 120, identical to that described in reference to the first conveying device D1. This cleaning device 120 is adapted to clean the transport surface of the impression cylinder 54.

All of the features of the cleaning device 120 described in connection with the conveying devices D1 and D2 are similarly applicable to the conveying devices D3 to D5.

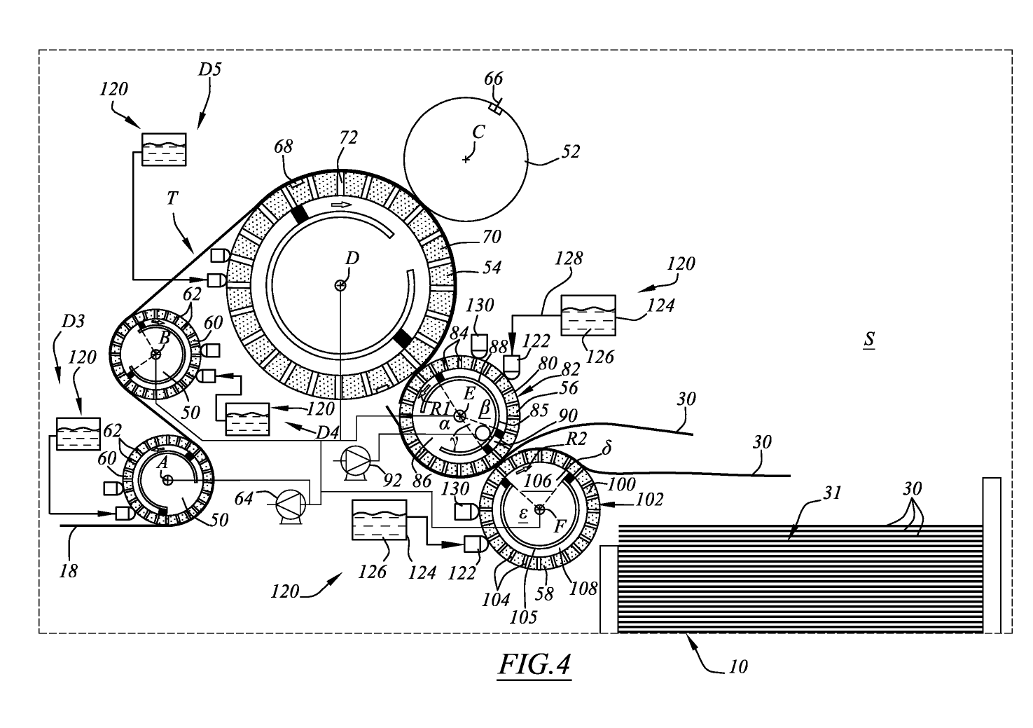

FIG. 4 shows a cutting device 10 according to a second embodiment of the invention, which differs from the embodiment previously described as follows. Similar elements bear the same references.

The cleaning liquid 126 of the washing liquid is for example a hydrocarbon-based ink solvent. The cleaning device 120 also includes a wiping device 130 adapted to remove washing liquid from the transport surface 82, 102. The wiping device 130 is positioned downstream of the device applying the washing liquid 122, in the driving direction of the transport roll 56 or the braking roll 58.

Owing to the invention, the transport surface 82, 102 is clean when a sheet 30 is deposited on each of the transfer 56 and braking 58 rolls, and the printing quality is increased.

During use, the web of paper 18 is printed by the printing units 6, the web of printed paper 18 enters into the cutting device 10.

Then, the web of paper is cut into sheets 30 by the cutting 52 and impression 54 cylinders and the sheets 30 are supplied to the first conveying device D1.

A vacuum or a depression is created in each of the holes 84, 104 situated in the first angular range α, δ.

The sheet 30 is conveyed on the transport surface 82, then is blown towards the transport surface 102 by the overpressure chamber 90.

Then, the sheet 30 is braked by the braking roll 58 and positioned on the stack 31.

The cleaning liquid 126 is applied continuously on part of the transport surface 82, 102 while another part of said transport surface 82, 102 conveys a sheet 30.

In other words, after the sheet 30 has left the part of the transport surface 82, 102 and before the following sheet 30 comes into contact with said part of the transport surface 82, 102, the cleaning liquid 126 is applied on said part of the transport surface.

The cleaning device can be used to clean the transport surface of any type of cylinder for transporting a flat substrate, such as a sheet or a web.

What is claimed is:

1-13. (canceled)

14. A device for conveying a flat substrate, such as a sheet or a web comprising:
a transport roll for conveying a flat substrate to be transported, the transport roll having a transport surface in contact with the flat substrate during the transport and provided with a plurality of recesses;
a vacuum device creating a depression in the plurality of recesses; and
a device for cleaning the transport surface.

15. The conveying device according to claim 14, wherein the cleaning device includes an application device applying cleaning liquid on the transport surface.

16. The conveying device according to claim 15, wherein the cleaning device comprises a tank containing cleaning liquid, and a duct adapted to convey the cleaning liquid to the application device.

17. The conveying device according to claim 16, wherein the cleaning liquid is ink repellant liquid.

18. The conveying device according to claim 16, wherein the cleaning liquid is a washing liquid, and the cleaning device includes a wiping device to remove the washing liquid from the transport surface.

19. The conveying device according to claim 18, wherein the wiping device is arranged downstream of the device applying the washing liquid, in the driving direction of the transport roll.

20. The conveying device according to claim 14, wherein the conveying device defines a depression chamber extending over a first angular range around the axis of rotation of the transport roll, the first angular range extending over less than 360°, the vacuum device being connected to the depression chamber to create a depression in the recesses found exclusively in the first angular range, the conveying device defining an ambient chamber extending over a second angular range, recesses found in the second angular range being subject to the ambient pressure, and the cleaning device cooperating with the transport surface within the second angular range.

21. The conveying device according to claim 20, wherein the conveying device defines an overpressure chamber extending over a third angular range around the axis of rotation, the conveying device including an overpressure device connected to the overpressure chamber and to create an overpressure in the recesses found exclusively within the third angular range.

22. The conveying device according claim 14, wherein the transport roll is either an entrance roll, an impression cylinder, a transfer roll or a braking roll.

23. A device for cutting a web into sheets comprising:
a cutting cylinder having a blade;
an impression cylinder cooperating with the cutting cylinder, the cutting cylinder and impression cylinder cutting a flat substrate web into sheets; and
a first device for conveying cut sheets by the cutting and impression cylinders,
wherein the first conveying device is a device according to claim 14.

24. A device for cutting a web into sheets comprising:
a cutting cylinder having a blade;
an impression cylinder cooperating with the cutting cylinder, the cutting cylinder and impression cylinder cutting a flat substrate web into sheets;
a first device for conveying cut sheets by the cutting and impression cylinders; and
a second device for conveying sheets, positioned downstream of the first device for conveying sheets,
wherein the first conveying device and second conveying devices are devices according to claim 14.

25. A rotary printing press comprising:
an unwinder for a web to be printed;
a unit for printing on the web to be printed; and
a device for cutting the printed web into sheets, the cutting device being a cutting device according to claim 23.

26. A method of a conveying a sheet using the conveying device recited in claim 14, comprising the following steps:
creating a depression in at least part of the plurality of recesses;
providing a sheet to be conveyed;
conveying the sheet on the transport surface; and
cleaning the transport surface using the cleaning device.

27. The conveying device according to claim 17, wherein the ink repellant liquid is an emulsion of silicone and water

28. The conveying device according to claim 18, wherein the washing liquid is an ink solvent.

29. The device for cutting a web into sheets according to claim 23, wherein the first conveying device is a transfer device.

30. The device for cutting a web into sheets according to claim 24, wherein the second conveying device is a braking device.
